(19) United States
(12) Patent Application Publication
(10) Pub. No.: US 2011/0262235 A1
(43) Pub. Date: Oct. 27, 2011

(54) REUSABLE LOW COST DRILL FOR DRYWALL

(76) Inventors: Theodore F. Garfield, Purchase, NY (US); Gordon E. Kaye, Glens Falls, NY (US)

(21) Appl. No.: 12/765,863

(22) Filed: Apr. 23, 2010

(51) Int. Cl. B23B 51/02; B23B 41/00

(52) U.S. Cl. 408/125; 408/229; 408/225; 408/241 R

(57) ABSTRACT

A reusable low cost drill bit element for operative, removable attachment to a turning implement for drilling anchor installation holes, particularly of at least ½″ diameter, in drywall. The drill bit is comprised of a section to be engaged with the turning implement and to be turned therewith, a drilling section with angled step sections in common planes perpendicular to the drill bit axis to perpendicularly bore into the drywall and form a perpendicular through aperture of a desired diameter, and an element to prevent the drill bit from falling behind the wall so that it can be reused to bore additional holes for other anchor.

### FIELD OF THE INVENTION

This invention relates to reusable economical drills and drill bits for use in drilling anchor installation holes in drywall or other similar soft wall materials and particularly relates to plastic drill bits for use in installation of drywall anchors, requiring installation holes of at least ½″ diameter.

### BACKGROUND OF THE INVENTION

Drywall, otherwise also known as Sheetrock® (trademark of US Gypsum Corp.), plasterboard, gypsum board or wallboard, is a very common interior wall material, particularly in the United States. It is comprised of compressed gypsum powder sandwiched between thick paper layers. Drywall is made according to recognized dimensional standards of 4′×8′ sheets and with the most common thicknesses of construction drywall being ½″ and ⅝″. Some walls (requiring unusual strength or insulation) are constructed of double layer ½″ or ⅝″ drywall. Hospitals, for example, often utilize double ⅝″ drywall. Other relatively soft wall materials such as foamed gypsum are similar in aperturing characteristics, with the term “drywall”, as used herein, including such materials.

Interior walls are constructed with the drywall sheets being fastened in position by direct attachment (usually with special nails or screws) to support elements such as wooden or metal framing studs. These studs are typically laterally spaced 16″ apart in framing configurations with large sections of the drywall being unsupported by strong backing support elements. Hollows are formed behind the drywall and the walls so made are often referred to as hollow walls. These areas of unsupported drywall must be considered in order to effectively hang and support items directly on the walls. The drywall itself, comprised of paper and pressed gypsum powder, has a relatively low holding strength and breakage point. To increase weight load bearing, various anchors called “drywall” or “hollow wall” anchors have been developed and are commercially available for hanging and supporting items directly on the drywall.

Ideally, heavy and non-static items such as cabinets, bookcases, televisions and the like when supported on interior walls made of drywall are most commonly directly fastened to the much stronger supporting studs, by bolts or screws (with measurements for centering and positioning being required to “catch” the studs). However, lighter items such as pictures, hat racks, telephones, etc., may be supportable directly by the drywall itself, with the use of the drywall or hollow wall anchors. Heavier items of intermediate weight (with static loads) are also often supportable by using a number of the drywall or hollow wall anchors, particularly hollow wall anchors with high load capacity, to safely spread the weight load behind the wall.

These high load capacity drywall anchors (that are not anchored to supporting studs), and drywall anchors in general (except for anchors for the very lightest of items), all require through-perforation of the wall to provide anchoring access to the rear or blind side of the wall, with a cross piece spanning and holding against a section of the rear of the wall. The greater the span, the more the weight distribution and the higher the load capacity of the anchor. This higher load capacity is, however, offset by the greater difficulty involved with installation of the larger high load capacity anchors.

Some anchors, such as plug anchors and self-drilling anchors, provide lesser holding and stability, since they rely only, or primarily, on an engagement with the powdered gypsum of the interior walls of the perforations or holes in the wall (without the deployment of a cross piece on the blind side of the wall). They are used only for light loads and are popular because of the ease with which they can be installed.

Anchors that provide more than a minimum of holding capability, however, require insertion holes or apertures for deployment behind a wall. Usually, the larger the anchor, the greater the hole diameter required for placement of the anchor. The most common manner of forming the through perforations or installation apertures for non-self installing anchors is with a drill and suitable size drill bits. In a pinch, for smaller anchors requiring smaller insertion apertures, spade type drill substitutes may be utilized, such as slotted screwdrivers (not, however, the narrower Phillips screwdrivers).

Simple percussion punching of an insertion hole, though simple, is however highly undesirable since it often results in wall breakage or “blow outs” with resultant areas lacking significant holding area or with more severely damaged walls, that do not permit proper placement of the anchors at all. Accordingly, a drilling or rotary type of hole formation is generally required to provide clean holes and to avoid the “blow out” breakage or damage to the fragile drywall.

In the past, in some anchor embodiments, and in order to simplify or expedite insertion hole formation, anchors have included forward end self drilling elements, such as separate (as in U.S. Pat. No. 4,617,692) or integrated drilling structures (similar to the self drilling anchors referred to above, wherein the entire anchor itself is a threaded element). These expedients and drilling elements of all types of self drilling anchor structures, however, almost always, remain in or on the blind side of the wall and are not re-usable with other anchors.

An additional problem with installing drywall anchors is with respect to anchors that extend to engage greater areas of the blind side of the wall, providing greater holding ability. However, installation of these greater extending anchors, such as anchors known as “toggle bolt anchors”, often requires the forming of large access holes of ½″ diameter or more. This is additionally problematic for expedited installation since many drill kits have maximum bit sizes of ⅜″. Furthermore, even with the typically larger size spade bits, with width of ½″ or more, such as used for drilling apertures in wood, the bits are subject to wandering or are difficult to properly position and locate a hole for proper placement of items on a wall. These drill bits are also subject to free-hand canting, with imprecise hole formation, which is manifested with the formation of non-perpendicular apertures through the wall. Deviation from perpendicular often leads to improper seating of an inserted drywall anchor that then results in loss of some or most of the anchor holding capacity. In addition, it can result in more serious problems of actual inoperability since threading an improperly seated anchor with an item-supporting bolt may be precluded. This imprecise non-perpendicular hole formation is particularly exacerbated with slow hand drilling, whereby precise hole formation is difficult to initiate as well as to maintain.

Furthermore, from an economical point of view, half-inch drill bits, suitable for use with electric drills, are almost invariably made of metal and cost at least several dollars or more, depending on quality. Such drill bits are thus not economically suitable for being provided as inserts with anchors that cost considerably less than the drill bit.

### SUMMARY OF THE INVENTION

It is accordingly an object of the present invention to provide an economical low cost drill bit that is re-usable, that is stable and precise in perpendicular hole formation, even with slow hand drilling, and is capable of making a through perforation aperture or hole in drywall of at least ½″ diameter by means of attachment of the drill bit to a screwdriver, drill or other rotating driving implement.

It is a further object of the present invention to provide such low cost drill bit as being suitable for packaging as an insert with drywall anchors (for use in the installation of the anchors) and being comprised of a low cost plastic that is capable of maintaining suitable cutting surfaces for making a number of through perforation apertures in drywall for at least the number of drywall anchors in a package or container (typically ten to fifteen anchors) with which it is packaged.

Generally the present invention comprises a reusable low cost drill bit element configured for operative, removable attachment to a screwdriver, electric drill or other turning implement for drilling anchor installation holes in drywall. The drill bit comprises:
a) a section configured to be engaged with the screwdriver, or other manual turning implement and to be turned therewith,
b) a drilling section that is configured to bore into the drywall and form a through aperture of a desired diameter, and
c) an element to prevent the drill bit from falling behind the wall or remaining in the wall, so that it can be reused to bore additional holes for other anchors.

The drill bit is preferably comprised of a molded low cost plastic such as a standard 30% glass filled nylon material. The drill bit is also configured, even when made of relatively soft plastic, to have sufficient durability for multiple uses and to be relatively easy to use without excessive forces being required. The drill bit may be comprised of other low cost materials such as sheet metal, or die-cast metal not normally used with standard metal drill bits. The drill bits may also be made of part plastic and part metal such as a plastic body with metal insert(s).

The engaging section is preferably a slotted end of the drill bit, configured to engage the common flat head or Phillips screwdrivers (preferably in line with the drill bit), with the slots being further configured to be adapted to various sizes of these screwdrivers. If the drill bit is comprised of a non-metal such as plastic the engaging section may also, or alternatively, be configured to be held by a drill chuck whereby it can be turned by a drill as an available soft material drill bit.

The drilling section preferably comprises at least three separated longitudinal leg members that extend distally from the element configured for engaging the screwdriver or extend distally from a stop collar. The three or more leg members are preferably positioned circumferentially and equidistantly spaced from each other to provide at least a tripodal stability during hole boring or drilling and to provide a conduit for removal of loose gypsum. Four leg members are, however, more preferred because of greater ease in molding, even greater stability and the greater amount of available boring elements. Additional leg members, while within the ambit of the present invention, are less preferred since they may present difficulty with smaller and less durable boring elements (additional legs in a defined space may be of smaller individual dimension), more difficulty with molding and possibly as a blocking impediment to removal of loosened gypsum powder.

The leg members are positioned concentric to a longitudinal axis of the drill bit and are preferably of substantially equal length. The outer surfaces of the leg members circumscribe a cylinder with a diameter substantially equal to the predetermined final aperture diameter and are of a length at least, and preferably greater, than the width of the drywall being apertured. The leg members, at their distal ends, taper with tapered sections to a common drilling tip located substantially on the longitudinal axis of the drill bit. The tapered section of each of the leg members is configured to effect the drilling into the paper and gypsum of the drywall and is preferably comprised of a series of step elements having riser or face sections set at a cutting angle preferably between 45 to 60° into the clockwise rotation direction (the cutting angles being a compromise between sharpness and durability of the cutting elements).

A suitable but not limiting angle of the taper of the leg members to the drilling tip is about 30° and the number of step elements on each of the taper section ranges from one to six and preferably ranges from three to five, with a preferred number generally depending on the material of the drill bit as a function of durability, size and cutting capability. The taper sections and steps elements thereof are preferably congruent with each other, with the congruent step elements of the separate taper sections having front facing angled surfaces in substantially the same plane, perpendicular to the longitudinal axis of the drill bit.

The taper sections of each of the leg members meet at a front end of the drill bit to form a tip comprising a position locating and paper piercing member configured with a narrow or sharp tip and positioned and configured for initial placement in the approximate center of the anchor insertion hole that is to be formed. The tip should preferably have sufficient durability to start an anchor insertion hole in the initial paper layer of the drywall, for at least ten holes, and preferably 15 holes, with the drill bit being preferably formed from a relatively rigid plastic such as 30% glass filled nylon, and costing on the order of about 3 cents/drill bit (i.e., economically suitable as a throw away insert with a package of drywall anchors). After tip insertion, the drill bit is configured for stable perpendicular engagement and seating with the drywall material. The drill bit contains the step elements to help maintain the perpendicular engagement and seating throughout the boring of the hole.

After a hole or aperture is formed, the drill bit is prevented from continuing and falling behind the wall and is reusable by means of a stop element such as a collar that engages the wall around the formed aperture. Alternatively, the drill bit comprises a gripping section whereby the drill is constantly held, such as with a drill chuck.

Erosion of the drill bit, if it occurs, is gradual and may be attributable to frictional contact of the low cost plastic with the thick paper of the drywall. To compensate for or to delay the erosion, and to extend the usable life of the drill bit, the drill bit is formed, such as by molding, with at least one set and preferably at least three sets of radially disposed cutting elements on a plane perpendicular to a longitudinal axis of the drill bit. The cutting elements are preferably step-like elements with front edges that are angled toward the drilling tip in a clockwise direction (the standard drilling rotational direction). Cutting elements configured for counter-clockwise cutting rotation are also within the purview of the present invention. The cutting edges roughly follow a circular form in a clockwise or counterclockwise drilling direction. The edges, when cleanly formed by molding, are generally sufficiently sharp to effect the requisite cutting for a required number of apertures in drywall. Depending on the material of which the drill bit is comprised, continued use eventually may gradually increase the forces necessary to make apertures, as a result of erosive dulling of the edges. If cost is not a factor or is of secondary importance, the drill bit may be made of increasingly more expensive, stronger and/or harder materials including engineering plastics, sheet metal, and die cast metal as well as combinations of metal and plastic.

Cutting elements in a single plane serve to help stabilize the drill during drilling of the anchor insertion aperture such that the aperture is formed perpendicular to the drywall in aperture-expanding steps until the entire aperture is formed. The diameters of the planes of the cutting elements increase radially in a direction away from the initial placement tip. As a result, the drill effectively nibbles away at concentric circles of the drywall, to provide both continuous perpendicular stability throughout the “drilling” process as well as spreading of the cutting load and spreading the effects of the edge erosion among the various cutting elements. The spaced apart cutting elements in a single plane assist in holding the drill bit perpendicular to the surface being cut.

To enable the drill bit to be reusable, especially when used as an adjunct to a manual rotating device such as a screwdriver, the drill is preferably provided with a stop member, as described above, that prevents the drill bit from falling into the drilled hole. Additionally or alternatively, the drill is provided with a member configured for being externally firmly held whereby it is retained on the rotating device and does not fall behind the wall into which the aperture is formed. An extension, adapted to fit into a holding chuck, is another example of a holding member on the drill bit. The rear end of the drill bit is preferably provided with numerous slots and configurations such that it can be engaged with common driving implements such as various size screwdrivers and be rotatable by such implements.

The above and other objects, features and advantages of the invention will become more evident from the following discussion and drawings in which:

### SHORT DESCRIPTION OF THE DRAWINGS

FIGS. 1A and 1B are perspective rear and front views of the drill bit of the present invention;

FIG. 2 is side view of the drill bit of FIGS. 1A and 1B;

FIG. 3 is a side view of the drill bit of FIG. 2 rotated 90° along a longitudinal axis, to show a screwdriver insertion slot;

FIG. 4 is a cross section view of the drill bit of FIG. 3 showing the screw driver engaging area;

FIG. 5 is a rear end view of the drill of FIGS. 1A and 1B;

FIG. 6 is a front end view of the drill of FIGS. 1A and 1B;

FIG. 7 depicts the drill bit of FIGS. 1-5 during a beginning-intermediate stage of drilling an anchor-insertion hole in a drywall with widening progression of the hole shown in dashed lines;

FIGS. 8A-D depicts a sequence of a typical toggle bolt type anchor being inserted into the insertion hole of FIG. 7, when completed, and configured for use in hanging an object on a drywall; and

FIG. 9 shows a non-perpendicular hole formed by a prior art drill bit and an anchor being improperly seated thereby.

### DETAILED DESCRIPTION OF THE INVENTION AND DRAWINGS

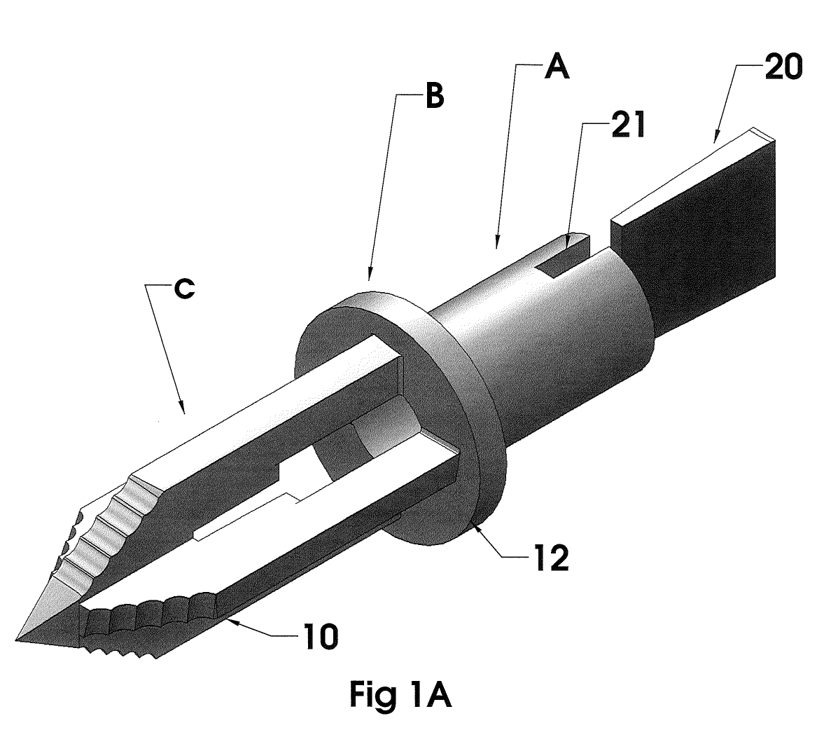

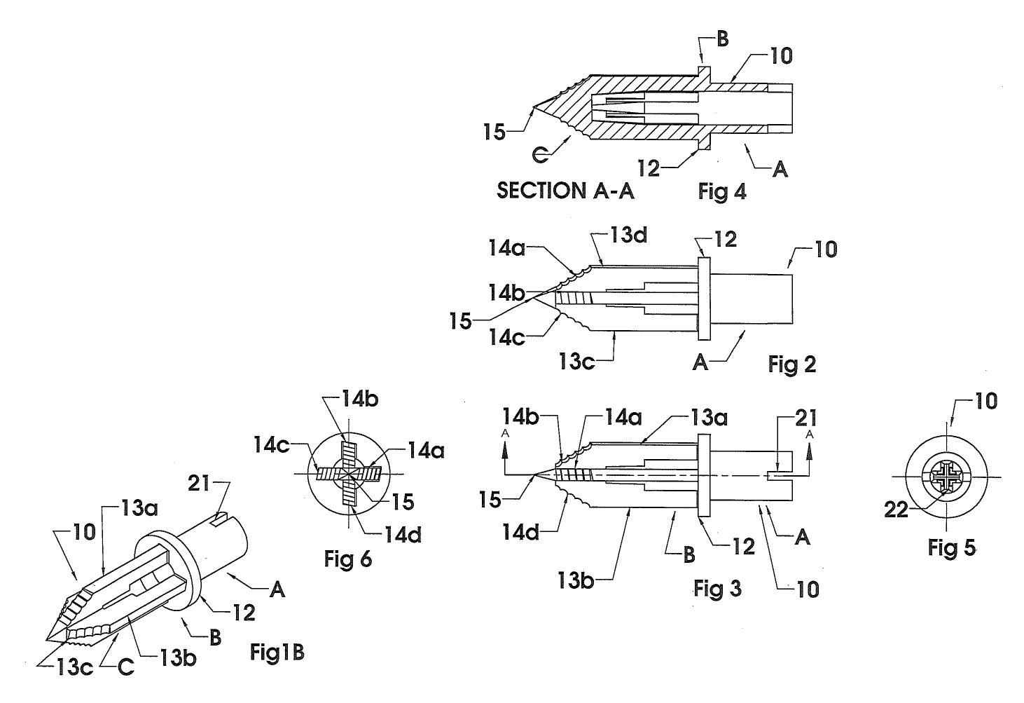

With specific reference to the drawings, a reusable drywall drill bit 10 of the invention is shown in various views and cross sections of FIG. 1A-FIG. 7, with three operative sections A, B and C.

Section A comprises the engaging and driving element with which the drill bit is operatively engaged with a rotating element such as a screwdriver 20 or a screw gun (not shown) whereby the drill bit is manually or mechanically rotated. Slot 21 is sized for engagement with spade screwdrivers and, as more clearly seen in FIG. 5, cross cut slot 22 is sized for engagement with Philips screwdrivers.

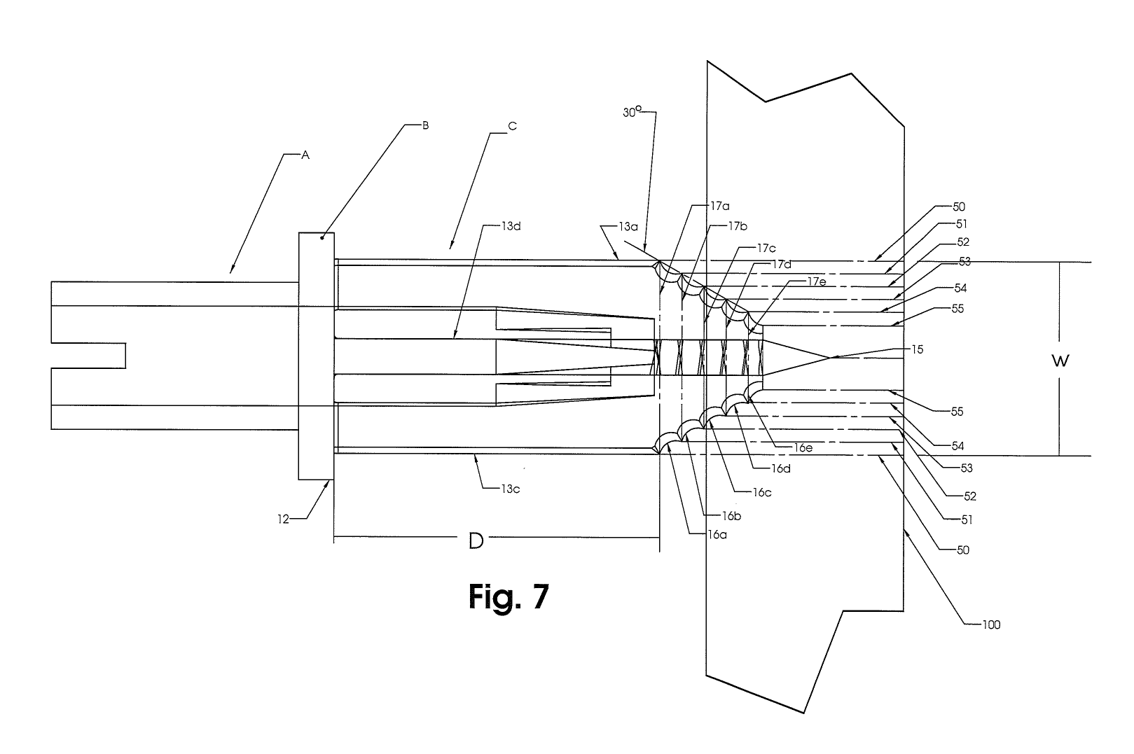

Section B comprises the retention element that serves to prevent the drill bit from continuing through its drilled hole and falling behind the wall being apertured. Collar or flange 12 serves as a stop, positioned at a distance from the drilling section C. As marked in FIG. 7. the distance from the collar 12 to the start of conical drill or cutting section 14 is sufficiently sized and dimensioned with length D to permit the uniform formation of the aperture, e.g. ½″ or width W, through at least the standard drywall of ⅝″ and optionally double width thickness of 1″ or 1 and 1/4″ thicknesses.

As shown, Section C is comprised of extending aperture defining legs 13a-d that are preferably circumferentially equidistant and spaced from each other. For ease in molding and reduction of production costs, the legs are even in number, with four legs being preferable to provide stability and effective cutting capability as well as to permit sufficient outflow movement of loosened gypsum through openings between in drill legs and prevent binding of the drill during use. The number of legs is further balanced between spreading the cutting load across more elements and the necessity of providing sufficient conduit space to allow detritus to flow back out of the path of the advancing drill.

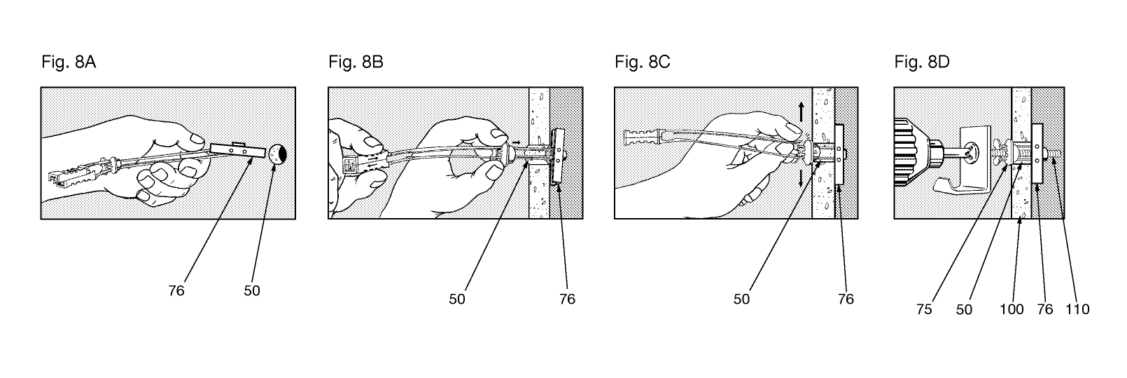

As shown in the view in FIG. 7, the legs 13a-d extend perpendicularly away from the collar 12 for a distance D at least equal to the thickness of the drywall 100 being apertured therewith (from ½″ to 1.25″, to accommodate double ⅝″ drywall thickness). Thereafter, the ends of the respective extension legs uniformly taper, with taper members 14a-d. to starter tip 15. As shown, the taper members are set at about a 30° conical angle, with each taper member comprising five step sections 16a-e with the respective steps of each of the taper members falling along 5 radial planes 17a-e but tilted, as more clearly seen in FIGS. 1,2,3 and 6. The tilting (between about 45 to 60°) provides the cutting elements for the step sections 16a-e. FIG. 7 shows the initial engagement of step 16b with the drywall surface and the stabilizing plane 17b. The dotted lines from respective steps 16a-e show the continued aperture 50 being progressively made as concentric circles 51-55, to requisite width W, in a stable perpendicular manner for insertion and proper seating of an anchor 75 as shown in FIGS. 8A-D.

FIGS. 8A-D sequentially depict the anchor 75 being inserted into drilled hole 50. As shown in FIG. 8D, hole 50 is perpendicular to the wall 100 whereby the inserted bolt 110 engages a threaded opening (not shown) in the cross bar part 76 of anchor 75 to effect a structurally sound holding in hollow wall 100.

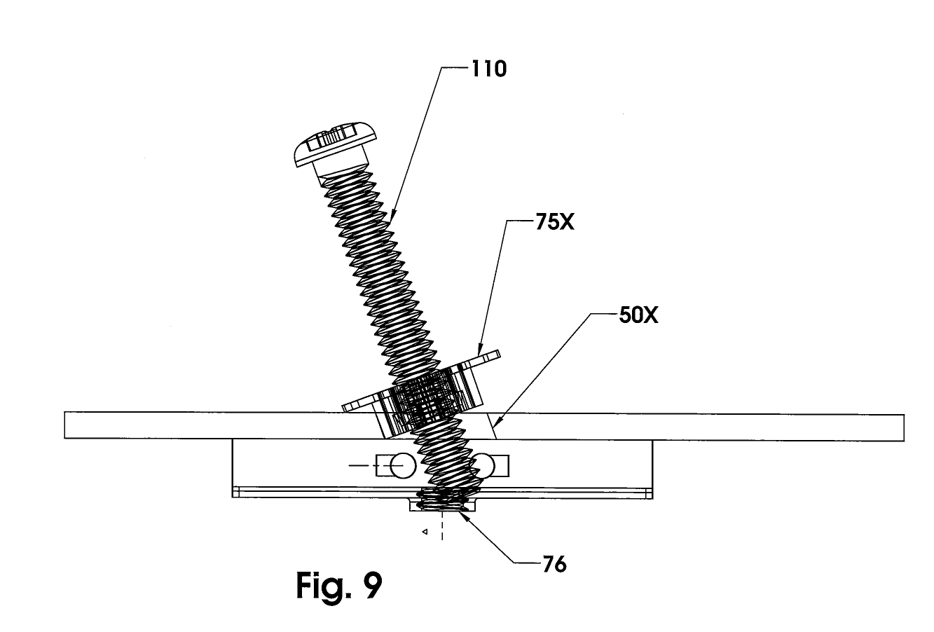

In contrast, as shown in FIG. 9, an aperture 50x formed in a non-perpendicular manner by a prior art drill bit, while allowing the anchor 75x to pass therethrough, does not allow for the requisite threading of the bolt 110 with a threaded opening in the cross bar part 76.

It is understood that the above description is merely illustrative of the present invention with changes in structure, components, operation and the like being possible without departing from the scope of the present invention as defined in the following claims.

What is claimed is:

1. A reusable drill bit configured for forming an aperture in drywall for insertion of a drywall anchor therethrough, the drill bit comprising:
i. an element configured for removable engagement of the drill bit with a rotatable driving implement for the rotatable driving of the drill bit with the implement;
ii. a drilling element configured for incrementally drilling concentric apertures of increasingly larger diameter in the drywall to a predetermined final aperture diameter of a size suitable for the insertion of the drywall anchor; and
iii. a retaining element configured for preventing the drill bit from continuing through the drywall, whereby the drill bit can be removed from the drywall for reuse.

2. The drill bit of claim 1, wherein the drill bit is comprised of a plastic material.

3. The drill bit of claim 2, wherein the plastic material is glass filled nylon.

4. The drill bit of claim 1, wherein the drill bit is comprised of metal or metal and plastic.

5. The drill bit of claim 4, wherein the metal is sheet metal or die-cast metal.

6. The drill bit of claim 1, wherein the reusable drill bit is configured to be removably engaged with a screwdriver as the rotatable driving implement.

7. The drill bit of claim 1, wherein the drilling element is configured to be supported and guided to be perpendicular to the drywall during the drilling of the concentric apertures.

8. The drill bit of claim 1, wherein the drilling element comprises at least three longitudinal leg members extending distally from the element configured for removable engagement of the drill bit with a rotatable driving implement, the leg members being circumferentially equidistantly spaced from each other and positioned concentric to a longitudinal axis of the drill bit, the leg members being of substantially equal length and having outer surfaces circumscribing a cylinder with a diameter substantially equal to the predetermined final aperture diameter and an extending length at least equal to the thickness of the drywall, the leg members each uniformly distally tapering with taper sections to a common drill section located substantially on the longitudinal axis, with the drill section being configured to cut through paper of the drywall, each of the taper sections comprising cutting elements configured to cut through the drywall at increasing larger distances from the longitudinal axis, with cutting elements of the respective taper sections of similar distance from the longitudinal axis being in substantially a same plane, perpendicular to the longitudinal axis.

9. The drill bit of claim 8, wherein the cutting elements comprise step elements having front end surfaces configured to engage the drywall with each front end surface being set at an angle extending toward the drilling tip in one of a clockwise or counterclockwise direction relative to the drywall being apertured.

10. The drill bit of claim 9, wherein the angle is between 45 to 60°.

11. The drill bit of claim 8, wherein the taper from each of the leg members to the common drill section is about 30°.

12. The drill bit of claim 8, wherein the drilling element is comprised of four longitudinal leg members.

13. The drill bit of claim 9, wherein each taper section comprises the same number of step elements and the number of step elements is three to five.

14. The drill bit of claim 13, wherein the number of step elements is five.

15. The drill bit of claim 8, wherein the retaining element comprises a collar stop member configured to engage the drywall peripheral to the aperture after the aperture is formed.

16. The drill bit of claim 8, wherein the retaining element comprises an elongated section configured to be held and retained by a chuck of a drill.

17. The drill bit of claim 8, wherein the predetermined diameter is at least 1/2″.

18. A reusable plastic drill bit configured for forming an aperture in a drywall for insertion of a drywall anchor therethrough, the drill bit comprising:
i. an element configured for removable engagement of the drill bit with a rotatable driving implement for the rotatable driving of the drill bit with the implement;
ii. a drilling element configured for drilling a predetermined aperture with a diameter of a size suitable for the insertion of the drywall anchor; and
iii. a retaining element configured for preventing the drill bit from continuing through the drywall, whereby the drill bit can be removed from the drywall for reuse.

19. The drill bit of claim 1, wherein the drill bit is packaged with up to 15 drywall anchors and the drill bit being configured and comprised of a plastic material with sufficient durability to effectively drill at least 15 apertures in the drywall for installation of the up to 15 drywall anchors with which it is packaged.
